(19) United States
(12) Patent Application Publication
(10) Pub. No.: US 2015/0207426 A1
(43) Pub. Date: Jul. 23, 2015

(54) Non-isolated AC input DC Driver

(71) Applicant: Transistor Devices, Inc. d/b/a TDI Power, Hackettstown, NJ (US)

(72) Inventor: John Santini, Columbia, NJ (US)

(21) Appl. No.: 14/600,759

(22) Filed: Jan. 20, 2015

Related U.S. Application Data
(60) Provisional application No. 61/929,310, filed on Jan. 20, 2014.

(51) Int. Cl. H02M 7/06

(52) U.S. Cl. CPC H02M 7/06

(57) ABSTRACT

A non-isolated AC input DC Driver in the form of a three phase rectifier followed by one or more balanced DC/DC buck converters.

### REFERENCE TO RELATED APPLICATIONS

This application claims one or more inventions which were disclosed in Provisional Application No. 61/929,310, filed Jan. 20, 2014, entitled “Non-isolated AC input DC Lamp Driver”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of AC/DC power supplies. More particularly, the invention pertains to DC driver circuits having multi-phase AC input.

2. Description of Related Art

Using multi-phase 480 VAC to power a DC drive circuit can be problematic because such voltages are at or above the point where accidental contact would be at best harmful and at worst fatal.

### SUMMARY OF THE INVENTION

The basis for the DC Driver is a three phase rectifier followed by one or more balanced DC/DC buck converter. A preferred embodiment uses four balanced buck converters in a four-phase arrangement.

### BRIEF DESCRIPTION OF THE DRAWING

FIG. 1 shows a high level circuit view of a driver with a three-phase rectifier and a single balanced buck converter.

FIG. 2 shows the circuit of FIG. 1, annotated for voltages and currents.

FIGS. 3a-3b show graphs of input voltages of the circuit of FIG. 1.

FIG. 3c shows a graph of the output voltage of the circuit of FIG. 1 at midpoint relative to earth ground.

FIG. 4 shows a high level circuit view of a driver with a three-phase rectifier and four balanced buck converters at four phases.

FIG. 5 shows a physical mockup of 20 KW converter.

### DETAILED DESCRIPTION OF THE INVENTION

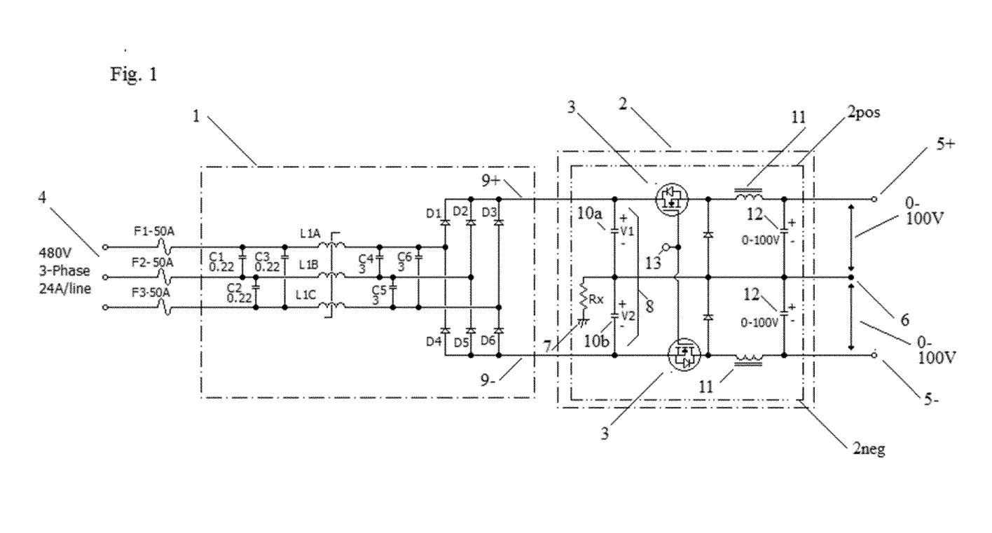

FIG. 1 shows a simplified schematic of an AC input DC Driver in the form of a three phase rectifier 1 followed by a balanced DC/DC buck converter 2. The balanced buck converter 2 is made up of a positive buck converter 2 pos and a negative buck converter 2 neg.

The rectifier 1 converts the three phase AC input 4 to a DC voltage on the bus 9+, 9−, each of which forms a power input to each of the positive and negative buck converters, respectively. The switches 3 in the balanced buck converter 2, herein shown as field effect transistors (FETs), convert this DC voltage to a pulsating DC voltage at a high frequency, for example 100 KHz, which is then filtered, for example by choke 11 and capacitor 12, to provide a cleaner DC output 5+, 5−.

The switches 3 are driven by a high frequency controller feeding a drive signal to a drive input 13 to accomplish the generation of the pulsating DC, here shown as a simple line connected to the gates of the FETs. Note that in the figures no specific drive circuitry or controller is shown, as this is intended as a high-level view of the novel circuit. Such drive circuitry will be required, but can be conventional in the art, and will be discussed in greater detail below. Note that the gates of the switches 3 are shown as connected in the figures for purposes of clarity and simplicity, but it will be recognized that the drive signals for each of the positive and negative buck converters actually may need to be DC isolated and/or controlled to maintain balance because of component limitations and phase balance requirements.

The three phase AC input 4 results in phase balance regardless of load or number of drivers used in a system. A feature of this topology is to minimize the common mode voltage to earth ground 7, which affects insulation resistance requirements and potential fault currents in the load.

Accordingly, the voltage from the outputs 5+, 5− to center tap 6 is the same—here shown as 100V—and one can put a sensor across the center tap-to-ground resistor Rx to detect and shut down if breakdown in isolation is indicated by current through Rx.

In order to maintain a relatively low common mode output voltage with respect to earth ground 7, the balanced buck converter 2 is configured with a capacitive divider 8 comprising capacitors 10a, 10b, off the rectified DC bus 9+, 9−. These capacitors 10a, 10b provide low impedance at the switching frequency (i.e. 100 KHz) for ripple suppression. Their capacitance is low enough that they provide minimal energy storage at the power line frequency (60 Hz or 120 Hz).

It should be noted here that where specific voltages, currents or frequencies are given herein, they are to be considered as examples and not limiting to those specific values. The actual voltages, currents or frequencies for a given circuit will depend upon the specific requirements of the apparatus in which the driver might be used.

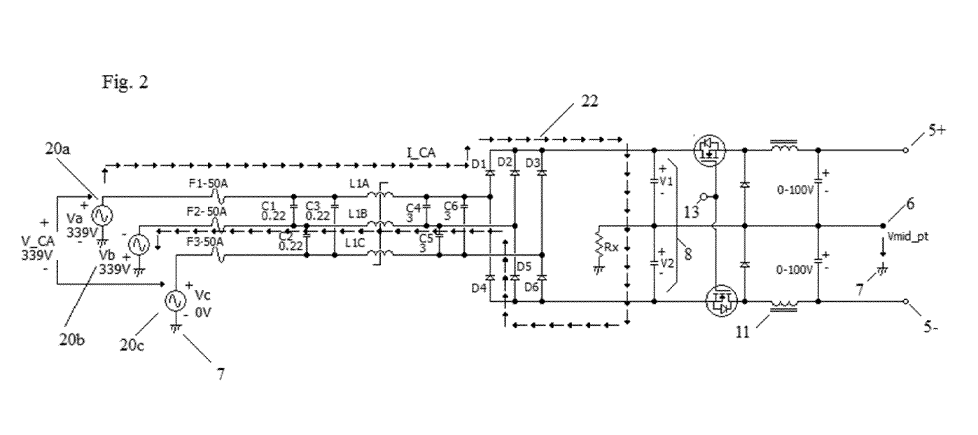

FIG. 2 presents the circuit topology of FIG. 1, annotated with regard to voltages and current flow. AC Input voltage is modeled as three separate voltage generators 20a, 20b, 20c connected to earth ground 7. Phase to ground voltages Va, Vb and Vc are set so this system could also be represented as a Delta Input connection with 480 VAC from phase-to-phase. FIG. 2 is annotated to show current flow 22 and voltage distribution at the positive peak of the voltage V_AB from phase-A to phase-B. Similar analysis can be done for other operating points—V_CA from phase-C to phase-A, and V-BC from phase-B to phase-C.

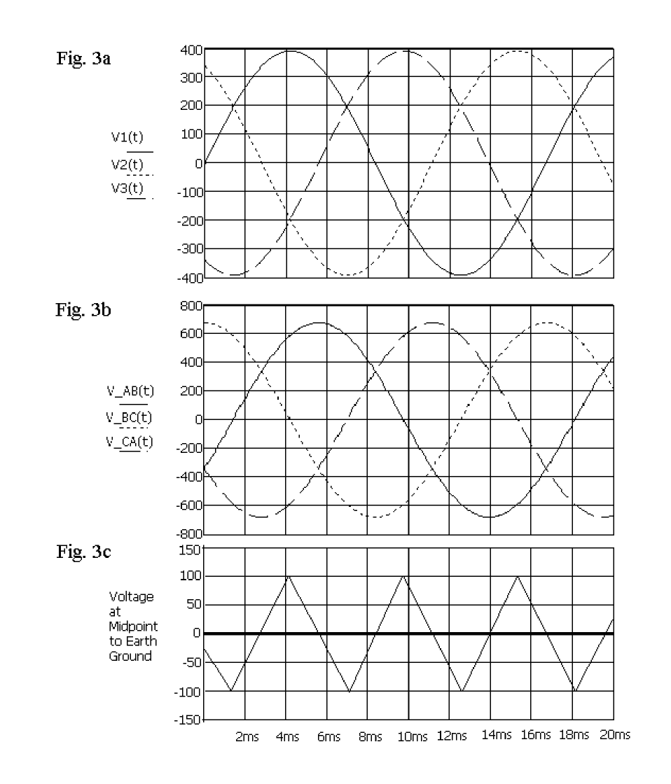

As derived from FIG. 2 and shown in FIGS. 3a-c, the center point 6 of the divider 8 is near Earth ground 7, with approximately 25% of the AC input phase voltage appearing at this node with respect to Earth Ground 7. So with 480 VAC input, the common mode voltage with respect to ground will be 97 volts peak at 3× the line frequency. In addition, at each output terminal 5+, 5−, half the DC output voltage will be seen with respect to earth ground 7, so the maximum instantaneous output voltage with respect to earth ground (at maximum output voltage) will be 97+(200/2)=197 volts.

This compares to a maximum voltage with respect to earth ground of 1.414×120V=170 volts for a prior art 120/208 three phase system. It should also be noted that the common mode voltage to ground decreases linearly with DC output in the DC system, but the peak voltage remains the same with a phase controlled AC system. So at 50% output, the DC system only has 122 volts with respect to ground but the AC system still has 170 volts to ground.

FIG. 3a shows a graph of phase to ground voltages Va, Vb and Vc over time, and FIG. 3b shows a graph of phase-to-phase voltages V_AB, V_BC and V_AC over the same time. FIG. 3c shows a graph of the voltage Vmid_pt at midpoint or center tap 6 relative to earth ground 7 corresponding to the same time as FIGS. 3a and 3b.

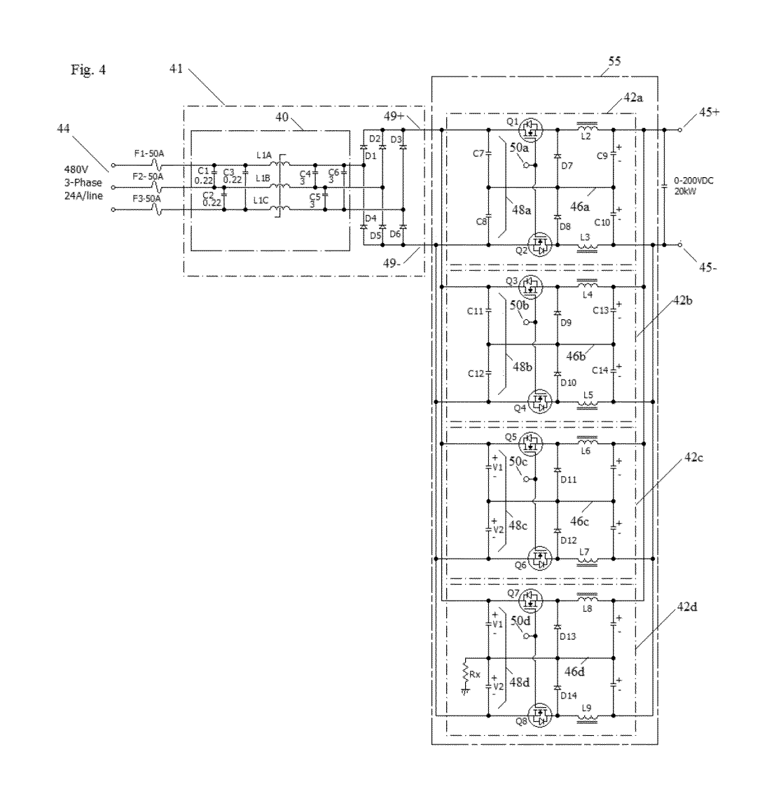

A general high-level view of the a preferred embodiment of the driver is shown in FIG. 4, composed of a three phase rectifier 41 feeding four balanced buck converters 42a-42d making up a four-phase DC/DC converter 55.

More specifically, the AC input is three phase at 60 Hz 120 degrees apart. This is rectified to DC in a rectifier. Then, four buck converters convert the DC to four phases of pulsating DC at 100 KHz, 90 degrees apart.

The three phase AC input 44 first passes through an EMI filter 40 which reduces high frequency emissions. Inductors L1a-L1c form a three winding common mode choke, and these inductors with C1-C6 form a Pi filter.

Diodes D1-D6 in rectifier 41 rectify the three phase power 44 producing a DC bus 49+, 49− which is nominally 650 VDC with 480 VAC input. This configuration results in very low DC ripple on the bus with no requirement for bulk holdup capacitance.

This DC bus 49+, 49− then feeds four balanced buck converters 42a-42d, and as in the circuit of FIG. 1, each balanced buck converter 42a-42d is comprised of a positive buck converter and a negative buck converter. Each balanced buck converter 42a-42d is driven from one phase of a four phase clock at a drive input 50a-50d, with the phases staggered 90 degrees apart. As a result, both input and output ripple tend to cancel, with complete cancellation occurring when the output voltage is ¼ the input voltage.

The drive inputs 50a-50d are indicated as “Drive 0”, “Drive 90”, etc., indicating that the four drive inputs 50a-50d drive the four balanced buck converters 90° apart. These drive inputs 50a-50d could be derived from standard pulse-width modulated (PWM) drive circuitry, and could be implemented through use of standard controller chips, or other controller known to the art. For example, a special purpose four phase DC/DC controller IC could be used, such as the HIP6303 Microprocessor CORE Voltage Regulator Multi-Phase Buck PWM Controller manufactured by Intersil of Melbourne, Fla. This device has the advantage of being an integrated controller for all four phases. However, it would need to be adapted to the required output voltage, and current sensing is via Rds(on) monitoring. A more conventional method would be to simply use 4 PWM controller circuits, for example using the UC3844 Current-Mode PWM Controller manufactured by Texas Instruments, synchronized to a four phase clock.

In order to maintain a relatively low common mode output voltage with respect to earth ground, each balanced buck converter 42a-42d is configured with a capacitive divider 48a-48d off the rectified DC bus 49+, 49−. The center point of the dividers—46a formed by C7/C8, 46b by C11/C12, 46c by C15/C16 and 46d by C19/C20, forms a phantom ground point. The positive buck converters and negative buck converters in each of the balanced buck converters 42a-42d are with respect to this point, controlled with the identical PWM gate drive signal 50a-50d. Consequently, the resulting DC output is centered on the phantom ground point, which is always within 100 volts of earth ground.

In addition, the fact that the drive signals are always identical means that the positive and negative halves will always remain balanced, within the tolerances of the inductors and capacitors. Any imbalance, if externally induced, would result in higher current in the higher voltage side which would bring the converter back into balance, without the need for additional balancing circuitry.

Referring to the first balanced buck converter 42a in FIG. 4, when switches Q1 and Q2 close, current flows from the input DC bus 49+, 49− through inductors L2 and L3, delivering current to output capacitors C9 and C10 and the load attached to output 45+, 45−. When Q1 and Q2 open, diodes D7 and D8 are forward biased by inductors L2 and L3, and current continues to flow to the output 45+, 45−. Ripple current in the inductors will be approximately 10A P-P at full load. The duty cycle of the drive signal at signal input 50a is controlled to produce the required DC output, while remaining synchronized to the other three buck converters 42b-42d.

The fact that the ripple of the four phases is cancelled allows the use of relatively small output capacitors, which in turn allows relatively fast programming of the outputs.

A physical mockup of a single driver module 60 for a system using the circuits described above is shown in FIG. 5.

In an example system, a rack assembly might contain a number of independently controlled driver modules 60, for example three modules each rated for, say, 20 kW, for a total of 60 kW per assembly. The rack assembly could be implemented as a shelf providing power connections for each driver module 60, and could also be equipped with water fittings for cooling the modules. Multiple assemblies could be stacked up to provide whatever power capability is required.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A non-isolated AC input DC driver having an AC input, a positive DC output and a negative DC output balanced with respect to a center tap, comprising:
a) a rectifier having an AC input coupled to the AC input of the non-isolated AC input DC driver, a positive DC output and a negative DC output;
b) at least one balanced buck converter having a positive DC input coupled to the positive DC output of the rectifier, a negative DC input coupled to the negative DC output of the rectifier, a drive input, and a positive DC output and a negative DC output balanced with respect to a center tap, each balanced buck converter comprising:
i) a positive buck converter having a power input coupled to the positive DC input of the balanced buck converter, a drive input coupled to the drive input of the balanced buck converter, and an output coupled to the positive DC output of the balanced buck converter;
ii) a negative buck converter having a power input coupled to the negative DC input of the balanced buck converter, a drive input coupled to the drive input of the balanced buck converter, and an output coupled to the negative DC output of the balanced buck converter; and
iii) a capacitive divider comprising a first capacitor coupled between the positive DC input of the balanced buck converter and the center tap and a second capacitor coupled between the negative DC input of the balanced buck converter and the center tap;
c) a high frequency controller providing a drive signal coupled to the drive input of the balanced buck converter to cause the balanced buck converter to generate pulsating DC at high frequency;
d) a filter coupling the positive DC output of the at least one balanced buck converter to the positive DC output of the non-isolated AC input DC driver; and
e) a filter coupling the negative DC output of the at least one balanced buck converter to the negative DC output of the non-isolated AC input DC driver.

2. The non-isolated AC input DC driver of claim 1, in which there are four balanced buck converters and the high-frequency drive signal comprises four drive signals ninety degrees apart in phase, each drive signal being coupled to the drive input of one of the four balanced buck converters, such that the four balanced buck converters form a four-phase DC/DC converter.

3. The non-isolated AC input DC driver of claim 1, in which the high-frequency controller provides a pulse width modulated drive signal to the at least one balanced buck converter.

4. The non-isolated AC input DC driver of claim 1, in which the AC input is three-phase.

5. The non-isolated AC input DC driver of claim 1, in which the AC input is coupled to the AC input of the rectifier through an EMI filter for reducing high frequency emissions.
